(19) United States
(12) Patent Application Publication
(10) Pub. No.: US 2006/0044237 A1
(43) Pub. Date: Mar. 2, 2006

(54) Light emitting diode display

(76) Inventors: Kyoung Soo Lee, Suwon (KR); Ki Myeong Eom, Suwon (KR); Jin Hyun Choi, Suwon (KR)

Correspondence Address: MCGUIREWOODS, LLP, 1750 TYSONS BLVD, SUITE 1800, MCLEAN, VA, 22102, US

(21) Appl. No.: 11/209,767

(22) Filed: Aug. 24, 2005

(30) Foreign Application Priority Data
Aug. 25, 2004 (KR) 2004-67281

(51) Int. Cl. G09G 3/32

(52) U.S. Cl. 345/82

(57) ABSTRACT

A light emitting diode display including a pixel portion arranged on a substrate and having a plurality of data lines, scan lines, and pixels, a first power line for supplying a first pixel drive voltage to the pixels, a plurality of pixel power lines coupled to the first power line and for supplying the first pixel drive voltage to the respective pixels, and a plurality of compensation elements provided between respective pixel power lines and the first power line and having different resistances.

### CROSS-REFERENCE TO RELATED APPLICATION

This application claims priority to and the benefit of Korean Patent Application No. 10-2004-0067281, filed on Aug. 25, 2004, in the Korean Intellectual Property Office, the disclosure of which is incorporated herein by reference.

### BACKGROUND

1. Field of the Invention

The present invention relates to a light emitting diode display, and more particularly, to a light emitting diode display capable of reducing an IR drop of a power line, thereby increasing luminance uniformity.

2. Discussion of the Background

Recently, various thin, lightweight flat panel displays have been developed to replace the bulkier and heavier cathode ray tube (CRT). Such flat panel displays include a liquid crystal display, a field emission display, a plasma display panel, and a light emitting display.

The light emitting diode display is a self-emissive display that emits light when electrons and holes recombine in a fluorescent material. Such displays may be inorganic displays, which include an inorganic emitting layer, and organic displays, which include an organic emitting layer. These light emitting diode displays may have a fast response time, like a CRT, as compared to a display, such as a liquid crystal display, that requires a separate light source.

FIG. 1 is a diagram showing a typical light emitting diode display.

Referring to FIG. 1, a typical light emitting diode display may comprise a substrate 10; a pixel portion 20 having a plurality of pixels 21 arranged in an area defined by scan lines S, data lines D, and pixel power lines VDD formed on the substrate 10; a scan driver circuit 30; a data driver circuit 40; a first power source line 50; a second source power line 52; and a pad portion 60.

The scan driver circuit 30 is arranged adjacent to a side of the pixel portion 20 and is electrically connected to the first pads Ps of the pad portion 60 through a scan control line 32. The scan driver circuit 30 generates scan signals according to a scan control signal from the scan control line 32, and sequentially applies the scan signals to the scan lines S. The scan driver circuit 30 may include a plurality of shift registers that generate sequential scan signals in response to the scan control signal.

The data driver circuit 40 is electrically connected to the second pads Pd of the pad portion 60 through the first data signal lines 42 and is electrically connected to the data lines D through the second data signal lines 44. Here, the data driver circuit 40 may be mounted on the substrate 10 using, for example, a chip on glass method, a wire bonding method, a flip-chip method, or a beam lead method. The data driver circuit 40 receives a data control signal and a data signal from the second pads Pd, and it supplies data signals of one horizontal line per one horizontal period to the data lines D in response to the data control signal.

The second power source line 52 is arranged adjacent to a side of the pixel portion 20 and is electrically connected to a cathode of the light emitting diode, which is formed over the pixel portion 20. The second power source line 52 supplies the second pixel drive voltage, which is received from the third pads Pvss of the pad portion 60 through the second power supply line 56, to the cathode of the light emitting diode.

The first power source line 50 is arranged adjacent to the upper side of the pixel portion 20 and is electrically connected to one side of the pixel power line VDD. The first power source line 50 supplies the first pixel drive voltage, which is received from the fourth pads Pvdd of the pad portion 60 through the first power supply line 48, to the pixel power line VDD of each pixel 21.

One side of each pixel power line VDD is connected to the first power source line 50 in common, and the pixel power lines VDD supply the first pixel drive voltage from the first power source line 50 to the pixels 21.

Accordingly, each pixel 21 is controlled by the scan signal supplied to the scan line S, and emits light according to a current supplied to the light emitting diode from the pixel power line VDD. The amount of supplied current is based on the data signal supplied to the data line D.

The above-described typical light emitting diode has different voltage drops (IR) of the pixel drive voltage supplied to each pixel due to non-uniform line resistance according to a is length of each pixel power line VDD connected to the first power line 50 in common. In other words, the voltage drop of the pixel power line VDD decreases the closer the pixel power line is to the first power source line 50, while the voltage drop increases the farther the pixel power line is from the first power source line. Accordingly, the typical light emitting diode has a non-uniform voltage drop of the pixel power line VDD according to a position of the pixel 21, thereby creating non-uniform luminance due to varying current according to a pixel's position.

### SUMMARY OF THE INVENTION

The present invention provides a light emitting diode display that may reduce a voltage drop of a power line, thereby increasing luminance uniformity.

Additional features of the invention will be set forth in the description which follows, and in part will be apparent from the description, or may be learned by practice of the invention.

The present invention discloses a light emitting diode display comprising: an pixel portion arranged on a substrate and having a plurality of data lines, scan lines, and pixels; a first power line for supplying a first pixel drive voltage to the pixels of the pixel portion; a plurality of pixel power lines electrically connected to the first power line for supplying the first pixel drive voltage from the first power line to the respective pixels; and a plurality of compensation elements provided between the respective pixel power lines and the first power line and having different resistance values.

The present invention also discloses a light emitting diode display comprising: an pixel portion arranged on a substrate and having a plurality of data lines, scan lines, and pixels; a first power line for supplying a first pixel drive voltage to the pixels at one side of the pixel portion; an auxiliary power line for supplying the first pixel drive voltage to the pixels at the other side of the pixel portion; a plurality of pixel power lines electrically connected to the first power line and the auxiliary power line for supplying the first pixel drive voltages from the first power line and the auxiliary power line to the respective pixels; and a plurality of compensation elements provided at least one of places between the respective pixel power lines and the first power line and between the respective pixel power lines and the auxiliary power line, and having different resistance values.

The present invention also discloses a light emitting diode display comprising: an pixel portion arranged on a substrate and having a plurality of data lines, scan lines, and pixels; a first power line for supplying a first pixel drive voltage to the pixels of the pixel portion; a plurality of pixel power lines electrically connected to the first power line for supplying the first pixel drive voltage supplied from the first power line to the respective pixels; a plurality of common power lines connected in common to m pixel power lines (where, m is a positive integer); and a plurality of compensation elements provided between the respective common power lines and the first power line, and having different resistance values.

The present invention also discloses a light emitting diode display comprising: an pixel portion arranged on a substrate and having a plurality of data lines, scan lines, and pixels; a first power line for supplying a first pixel drive voltage to the pixels at one side of the pixel portion; an auxiliary power line for supplying the first pixel drive voltage to the pixels at the other side of the pixel portion; a plurality of pixel power lines electrically connected to the first power line and the auxiliary power line for supplying the first pixel drive voltages from the first power line and the auxiliary power line to the respective pixels; a plurality of common power lines connected in common to at least one of one side and the other side of m pixel power lines (where, m is a positive integer); and a plurality of compensation elements provided at least one of places between the respective common power lines and the first power line and between the respective common power lines and the auxiliary power line, and having different resistance values.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram showing a conventional light emitting diode display.

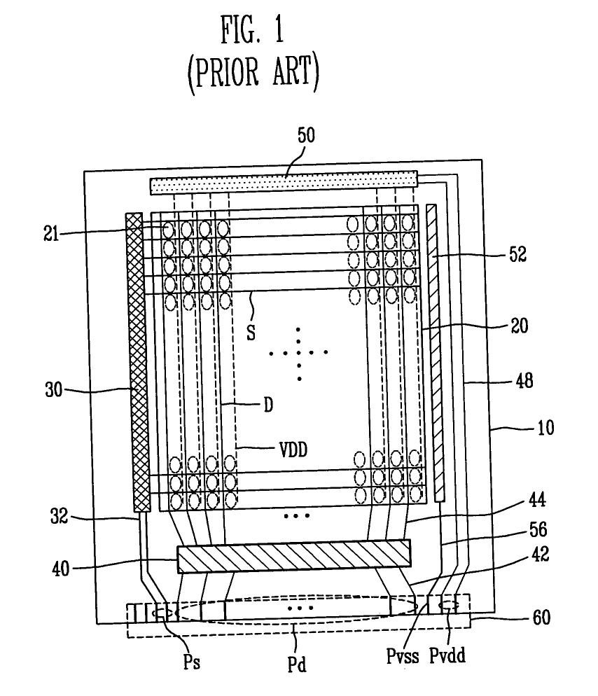

FIG. 2 is a diagram showing a light emitting diode display according to a first embodiment of the present invention.

FIG. 3 is a diagram showing enlarged compensation elements in portion A of FIG. 2.

FIG. 4 is a diagram showing alternative compensation elements in portion A of FIG. 2.

FIG. 5 is a circuit diagram showing respective pixels of FIG. 2.

FIG. 6 is a diagram showing current distribution according to positions of the pixels of FIG. 2.

FIG. 7 is a diagram showing a light emitting diode display according to a second embodiment of the present invention.

FIG. 8 is a diagram showing current distribution according to positions of the pixels of FIG. 7.

FIG. 9 is a diagram showing a light emitting diode display according to a third embodiment of the present invention.

FIG. 10 is a diagram showing current distribution according to positions of the pixels of FIG. 9.

FIG. 11 is a diagram showing a light emitting diode display according to a fourth embodiment of the present invention.

FIG. 12 is a diagram showing a light emitting diode display according to a fifth embodiment of the present invention.

FIG. 13 is a diagram showing current distribution according to positions of the pixels of FIG. 12.

FIG. 14 is a diagram showing a light emitting diode display according to a sixth embodiment of the present invention.

FIG. 15 is a diagram showing current distribution according to position of the pixels of FIG. 14.

FIG. 16 is a diagram showing a light emitting diode display according to a seventh embodiment of the present invention.

FIG. 17 is a diagram showing a light emitting diode display according to an eighth embodiment of the present invention.

FIG. 18 is a diagram showing a light emitting diode display according to a ninth embodiment of the present invention.

### DETAILED DESCRIPTION OF THE ILLUSTRATED EMBODIMENTS

Hereinafter, exemplary embodiments of the present invention will be described with reference to the accompanying drawings. Here, when one element is connected to another element, one element may be not only directly connected to another element but also indirectly connected to another element via another element. Further, non-essential elements may be omitted for clarity. Also, like reference numerals refer to like elements throughout.

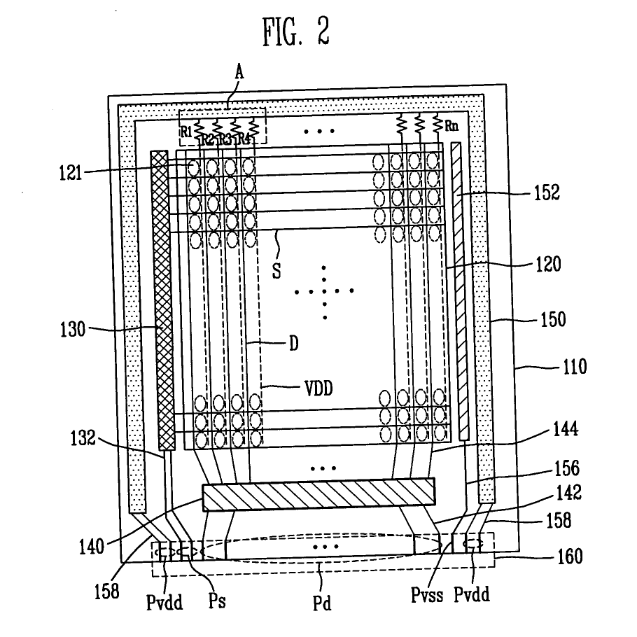

FIG. 2 is a diagram showing a light emitting diode display according a first embodiment of the present invention.

Referring to FIG. 2, the light emitting diode display according to the first embodiment of the present invention may include a pixel portion 120 arranged on a substrate 110 and defined by a plurality of data lines D, scan lines S and pixels 121; a first power line 150; a plurality of pixel power lines VDD; and a plurality of compensation elements R1 to Rn. The light emitting diode display may further include a scan driver circuit 130, a data driver circuit 140, a second power line 152, and a pad portion 160.

The scan driver circuit 130 may be arranged adjacent to a side of the pixel portion 120, and it may be coupled to the first pads Ps of the pad portion 160. The scan driver circuit 130 generates scan signals according to a scan control signal from a scan control signal line 132, and it may, for example, sequentially apply the scan signals to scan lines S of the pixel portion 120. The scan driver circuit 130 may include a plurality of shift registers for generating scan signals in response to a scan control signal.

The data driver circuit 140 may be coupled to the second pads Pd of the pad portion 160 through the first data signal lines 142 and coupled to data lines D through the second data signal lines 144. Here, the data driver circuit 140 may be mounted on the substrate 110 using, for example, a chip on glass method, a wire bonding method, a flip chip method, or a beam lead method, or it may be directly formed on the substrate 110. The data driver circuit 140 receives data control signals and data signals from the second pads Pd, and it supplies the data signals of one horizontal line per one horizontal period to the data lines D in response to the data control signals.

The second power line 152 may be arranged adjacent to a side of the pixel portion 120, and it may be coupled to a cathode of the light emitting diode, which is formed over the pixel portion 120. The second power line 152 supplies the second pixel drive voltage, which is transmitted from the third pads Pvss through the second power supply line 156, to the cathode of the light emitting diode.

As FIG. 2 shows, the first power line 150 may be arranged adjacent to left and right sides and the upper side of the pixel portion 120, and provided along an edge of the substrate 110 besides the pad portion 160. Both ends of the first power line 150 may be coupled to the fourth pads Pvdd of the pad portion 160 through the first power supply lines 158. The first power line 150 supplies the first pixel drive voltage, which is supplied from the voltage generation portion (not shown) through the first power supply line 158, to a first side of the pixel power lines VDD.

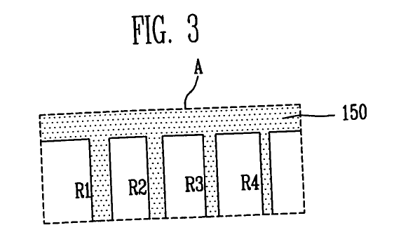

FIG. 3 is a diagram showing portion A of FIG. 2.

Referring to FIG. 2 and FIG. 3, the compensation elements R1 to Rn may be coupled between the first side of the respective pixel power lines VDD and the first power line 150, and they may have different resistances. For example, the respective compensation elements R1 to Rn may be provided with a different linewidth between the first power line 150 and the pixel power lines VDD.

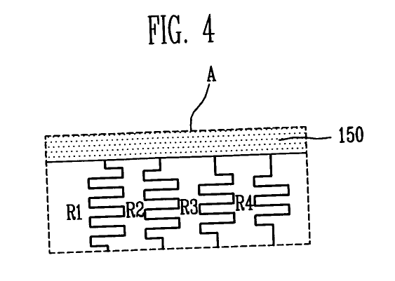

FIG. 4 is a diagram showing portion A of FIG. 2.

Referring to FIG. 2 and FIG. 4, the respective compensation elements R1 to Rn may be formed with the same linewidth but with different lengths between the first power line 150 and the pixel power lines VDD, so that they may have different resistances.

The resistance of first to n/2-th compensation elements R1 to Rn/2 may decrease approaching the n/2-th compensation element. Additionally, the resistance of the n/2+1-th to Rn-th compensation elements Rn/2+1 to Rn may increase approaching the n/2+1-th compensation element. Here, the k-th compensation element Rk and the n+1−k-th compensation element (Rn+1−k) may have the same resistance (where, k is a positive integer).

The respective compensation elements R1 to Rn may compensate for the impedance affecting the first pixel drive voltage, which is supplied from the first power line 150 to the first side of the pixel power lines VDD, such that the first pixel drive voltage supplied to the first side of the pixel power lines VDD may be substantially the same. Consequently, the first pixel drive voltage may be compensated to be substantially uniform by the respective compensation elements R1 to Rn.

As FIG. 2 shows, the first side of each pixel power line VDD may be coupled in common to the first power line 150 through the respective compensation elements R1 to Rn. Hence, each pixel power line VDD may be supplied with the first pixel drive voltage through the first power line 150 and the compensation elements R1 to Rn. Further, the pixel power lines VDD supply the first pixel drive voltage to the respective pixels 121.

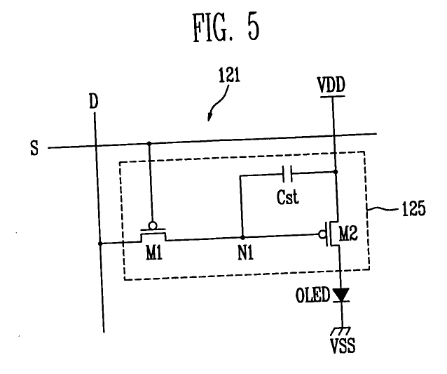

FIG. 5 is a circuit diagram showing the respective pixels 121 of FIG. 2.

Referring to FIG. 2 and FIG. 5, each pixel is controlled by the scan signal supplied to the scan line S, and emits light according to a current supplied from the pixel power line VDD to the light emitting diode to display an image. The supplied current is based on the data signal supplied to the data line D.

Each pixel 121 includes an organic light emitting diode OLED and a pixel circuit 125.

An anode of the organic light emitting diode OLED may be coupled to the pixel circuit 125, and its cathode may be coupled to a power VSS, which may be a ground voltage. Further, the organic light emitting diode OLED may comprise, for example, an emitting layer, an electron transport layer, and a hole transport layer, which are interposed between the anode and the cathode. Additionally, the organic light emitting diode OLED may further comprise an electron injection layer and a hole injection layer. When applying a voltage between the anode and cathode of the organic light emitting diode OLED, electrons generated from the cathode may move toward the emitting layer through the electron injection layer and the electron transport layer, and holes generated from the anode may move toward the emitting layer through the hole injection layer and the hole transport layer. Accordingly, the electrons and holes recombine in the emitting layer to emit light.

The pixel circuit 125 may comprise first and second transistors M1 and M2 and a storage capacitor Cst. Here, the first and second transistors M1 and M2 may be p-type metal oxide semiconductor field effect transistors (MOSFET), but the present invention is not limited thereto.

A gate electrode of the first transistor M1 is coupled to the scan line S, its source electrode is coupled to the data line D, and its drain electrode is coupled to a first node N1. The first transistor M1 supplies the data signal from the data line D to the first node N1 in response to the scan signal from the scan line S.

A gate electrode of the second transistor M2 is coupled to the first node N1, its source electrode is coupled to the pixel power line VDD, and its drain electrode is coupled to the anode of the organic light emitting diode OLED. The second transistor M2 adjusts a current between the source and the drain electrode supplied from the pixel power line VDD according to the voltage supplied to the gate electrode and then supplies the current to the organic light emitting diode OLED to emit light.

The storage capacitor Cst stores the voltage, which corresponds to the data signal, supplied on the first node N1 via the first transistor M1 in a period where a selection signal is provided to the scan line S, and then, when the first transistor M1 turns off, the second transistor M2 remains in an ON state for one frame.

The operation of pixels 121 will be now described. First, during a period of supplying a low selection signal to the scan line S, the first transistor M1 turns on. Therefore, the data signal supplied from the data driver circuit 140 to the data line D is supplied to the gate electrode of the second transistor M2 via the first transistor M1 and the first node N1. Here, the storage capacitor Cst stores a difference between the voltage of the gate electrode and the first pixel drive voltage supplied to the pixel power line VDD.

Accordingly, the second transistor M2 turns on according to the voltage of the first node N1 and supplies the current corresponding to the data signal to the organic light emitting diode OLED. Therefore, the organic light emitting diode OLED emits light according to the current supplied from the second transistor M2 to display images.

Next, during a period of supplying a high selection signal to the scan line S, the second transistor M2 remains ON due to the voltage corresponding to the data signal stored in the storage capacitor Cst so that the organic light emitting diode OLED emits light during one frame to display images.

The light emitting diode display according to the first embodiment of the present invention compensates a voltage drop of the pixel power lines VDD with the compensation elements R1 to Rn due to a line resistance according to a distance from the pad portion 160, so that the voltage drop of the first pixel drive voltage supplied to the respective pixel power lines VDD on the upper region of the pixel portion 120 relatively distant from the pad portion 160 may be minimized.

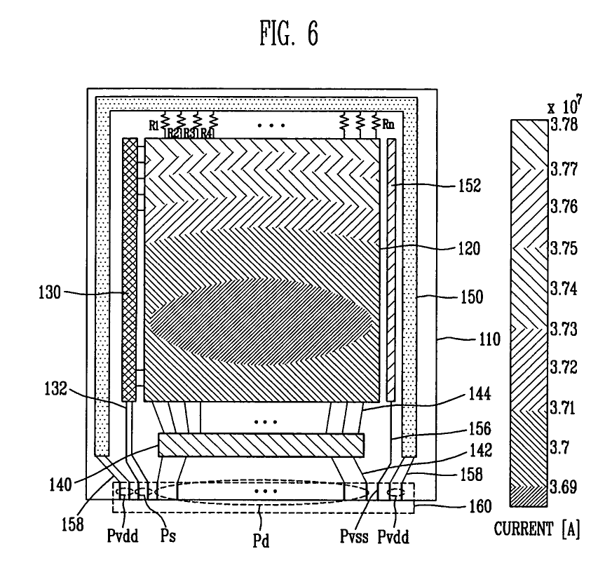

FIG. 6 is a diagram showing current distribution according to positions of the pixels of FIG. 2.

Referring to FIG. 6, with the light emitting diode display according to the first embodiment of the present invention, it is possible to minimize luminance non-uniformity caused by changes in the amount of current, supplied to each pixel, due to non-uniform voltage drops of the pixel power line according to the positions of the pixels 121 connected to one scan line. In other words, with the light emitting diode display according to the first embodiment of the present invention, it is possible to minimize non-uniform luminance at the left and right regions of the pixel portion 120 according to the position of the pixel 121.

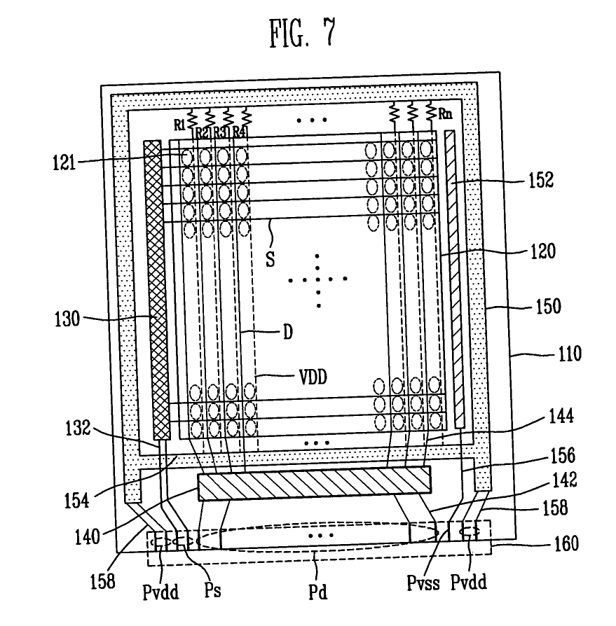

FIG. 7 is a diagram showing a light emitting diode display according to the second embodiment of the present invention.

Referring to FIG. 7, the light emitting diode display according to the second embodiment of the present invention may include the same elements as the display according to the first embodiment of the present invention, except that the former may further include an auxiliary power line 154. Thus, a description of the light emitting diode display according to the second embodiment of the present invention will be omitted here except for the auxiliary power line 154.

The auxiliary power line 154 may be arranged adjacent to the lower side of the pixel portion 120. The auxiliary power line 154 may be formed between the parallel first power lines 150 and coupled to the first power line 150.

Accordingly, the first side of each pixel power line VDD may be supplied with the first pixel drive voltage via the first power line 150 and the compensation elements R1 to Rn, and a second side of each pixel power line VDD may be supplied with the first pixel drive voltage via the first power line 150 and the auxiliary power line 154. Hence, the pixel power lines VDD supply the first pixel drive voltage, which is supplied via the first power line 150 and the auxiliary power line 154, to the pixels 121.

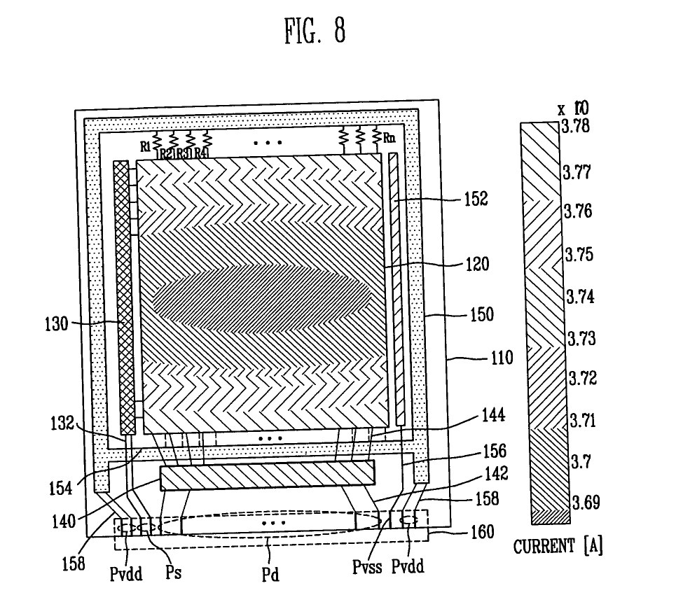

FIG. 8 is a diagram showing current distribution according to positions of the pixels of FIG. 7.

Referring to FIG. 8, the light emitting diode display according to the second embodiment of the present invention uses compensation elements R1 to Rn to provide a more uniform voltage drop of the first pixel drive voltage, which is supplied to the pixel power lines VDD. Additionally, the light emitting diode display according to the second embodiment of the present invention includes the auxiliary power line 154 to minimize non-uniformity of current distribution at the upper and lower regions of the pixel portion 120 by supplying the first pixel drive voltage to the pixel power lines VDD.

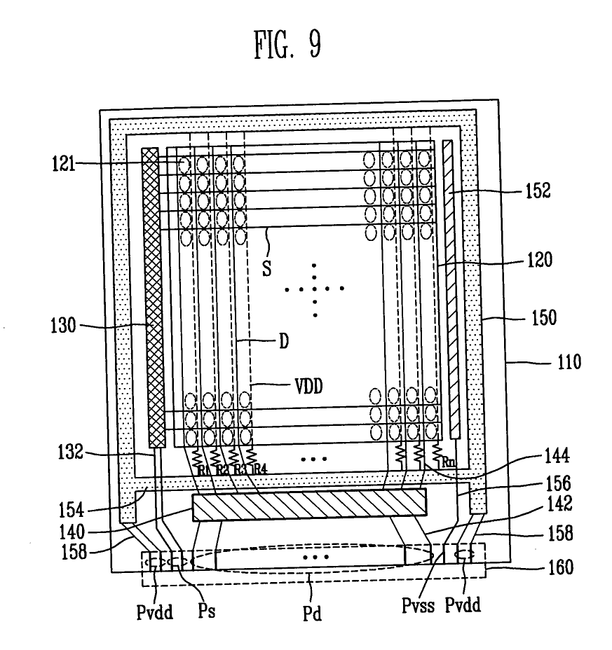

FIG. 9 is a diagram showing a light emitting diode display according to the third embodiment of the present invention.

Referring to FIG. 9, the light emitting diode display according to the third embodiment of the present invention is similar to the display according to the second embodiment of the present invention, except for an arrangement of the compensation elements R1 to Rn. Thus, a description of the elements other than the compensation elements R1 to Rn will be omitted here.

The compensation elements R1 to Rn of the light emitting diode display according to the third embodiment of the present invention may be coupled to the auxiliary power line 154 and the second sides of the pixel power lines VDD. Further, as described above, the compensation elements R1 to Rn/2 may have different resistances from each other, and the compensation elements Rn/2+1 to Rn may have different resistances from each other. In other words, the compensation elements R1 to Rn may be formed with different linewidths, as shown in FIG. 3, or they may be formed with the same linewidth but different lengths, as shown in FIG. 4.

The compensation elements R1 to Rn compensate for the impedance affecting the first pixel drive voltage supplied from the auxiliary power line 154 to the second side of the pixel power line VDD such that the first pixel drive voltage supplied from the first power line 150 to the first side of the pixel power line VDD is substantially equal to the first pixel drive voltage supplied from the auxiliary power line 154 to the second side of the pixel power line VDD. Consequently, the first pixel drive voltage supplied from the first power line 150 and the auxiliary power line 154 to the plurality of pixel power lines VDD may be made more uniform by the respective compensation elements R1 to Rn.

The first sides of the pixel power lines VDD may be coupled in common to the first power line 150 adjacent to the upper side of the pixel portion 120, and the second sides thereof may be coupled in common to the auxiliary power line 154 adjacent to the lower side of the pixel portion 120 through the respective compensation elements R1 to Rn. Hence, the first pixel drive voltage may be supplied to the first side of the pixel power lines VDD via the first power line 150, and the first pixel drive voltage may be supplied to the second side thereof via the power line 150, the auxiliary power line 154, and the compensation elements R1 to Rn. The pixel power lines VDD then supply the first pixel drive voltage to the respective pixels 121.

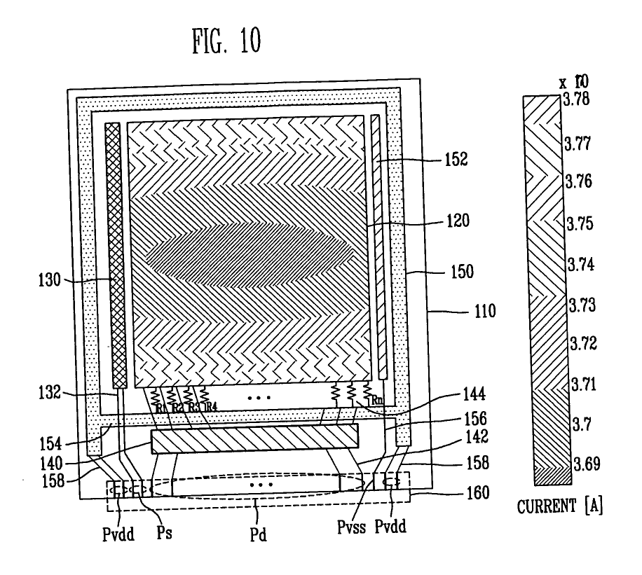

FIG. 10 is a diagram showing current distribution according to positions of the pixels of FIG. 9.

Referring to FIG. 10, the light emitting diode display according to the third embodiment of the present invention uses compensation elements R1 to Rn to provide a more uniform voltage drop of the first pixel drive voltage, which is supplied from the auxiliary power line 154 to each pixel power line VDD at the lower region of the pixel portion 120, to minimize non-uniformity of current distribution at the upper and lower regions of the pixel portion 120.

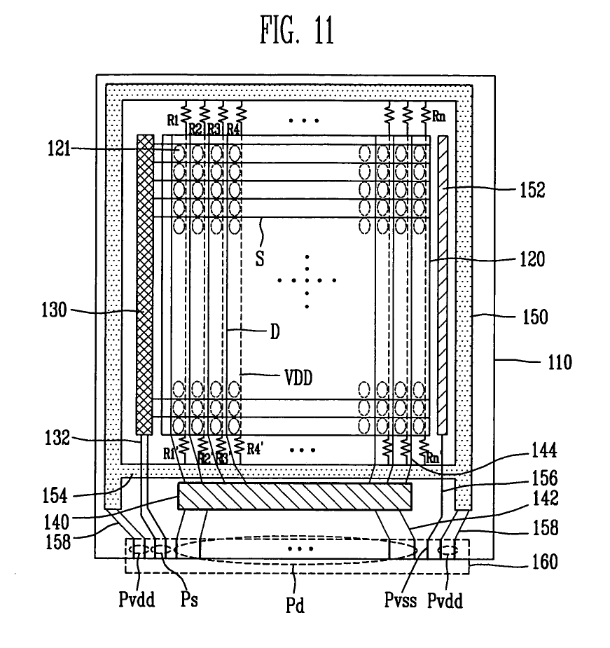

FIG. 11 is a diagram showing a light emitting diode display according to the fourth embodiment of the present invention.

Referring to FIG. 11, the light emitting diode display according to the fourth embodiment of the present invention is similar to the displays according to the second and third embodiments of the present invention, except for the inclusion of the first compensation elements R1 to Rn and the second compensation elements R1′ to Rn′, which may be coupled to first and second sides, respectively, of the pixel power lines VDD.

Thus, a description of the light emitting diode display according to the fourth embodiment of the present invention will be omitted here since its elements were described with regard to the second and third embodiments of the present invention.

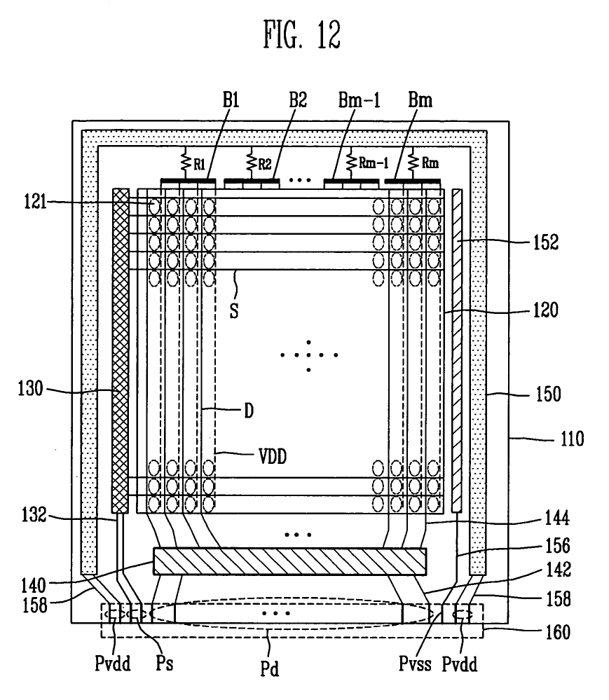

FIG. 12 is a diagram showing a light emitting diode display according to the fifth embodiment of the present invention.

Referring to FIG. 12, the light emitting diode display according to the fifth embodiment of the present invention may comprise a pixel portion 120 positioned on a substrate 110 and defined by a plurality of data lines D, scan lines S and pixels 121; a first power line 150; a plurality of pixel power lines VDD; a plurality of common power lines B1 to Bm; and compensation elements R1 to Rm.

The light emitting diode display according to the fifth embodiment of the present invention may further comprise a scan driver circuit 130, a data driver circuit 140, a second power line 152, and a pad portion 160.

The light emitting diode display according to the fifth embodiment of the present invention may have the same elements and arrangement as the display according to the first embodiment of the present invention, except for the plurality of pixel power lines VDD, the plurality of common power lines B1 to Bm, and compensation elements R1 to Rm, and thus, detailed description thereof will be omitted herein.

The common power lines B1 to Bm may be coupled in common to N pixel power lines VDD, respectively. Accordingly, the pixel power lines VDD may be divided into M blocks of N power lines by the common power lines B1 to Bm. The common power lines B1 to Bm may be formed between the first side of the pixel power lines VDD and the first power line 150.

The compensation elements may be coupled between the common power lines B1 to Bm and the first power line 150. Further, the compensation elements R1 to Rm/2 may have different resistances from each other, and the compensation elements Rm/2+1 to Rm may have different resistances from each other. In other words, the compensation elements R1 to Rm may be formed with different linewidths, as shown in FIG. 3, or they may be formed with the same linewidth but different lengths, as shown in FIG. 4. The compensation elements R1 to Rm compensate for impedance affecting the first pixel drive voltage supplied from the first power line 150 to the common power lines B1 to Bm.

The first sides of the pixel power lines VDD may be coupled in common to the first power line 150 adjacent to the upper side of the pixel portion 120 through the respective compensation elements R1 and Rm and the common power lines B1 to Bm. Hence, the pixel power lines VDD may be supplied with the first pixel drive voltage via the first power line 150, the compensation elements R1 to Rm, and the common power lines B1 to Bm.

In the light emitting diode display according to the fifth embodiment of the present invention, the compensation elements R1 to Rm are provided between the first power line 150 and the common power lines B1 to Bm where M groups of N pixel power lines VDD are coupled in common, so that the voltage drop of the first pixel drive voltage supplied to the pixel power lines VDD may be minimized in an M-block basis.

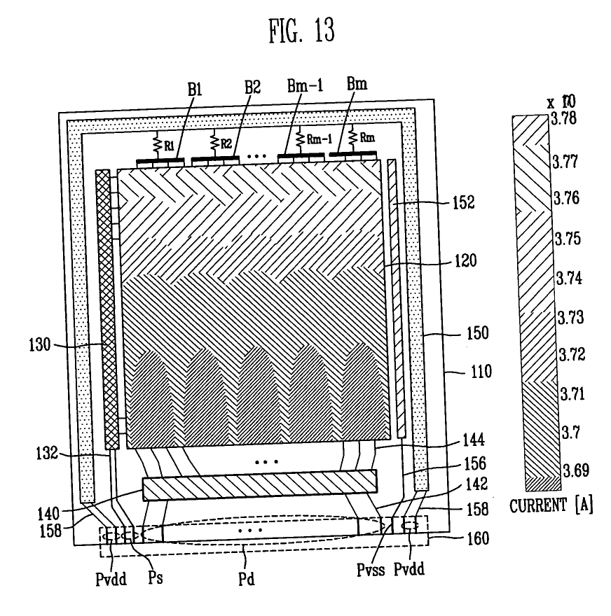

FIG. 13 is a diagram showing current distribution according to positions of the pixels of FIG. 12.

Referring to FIG. 13, the light emitting diode display according to the fifth embodiment of the present invention uses compensation elements R1 to Rm to minimize the non-uniform voltage drop of the first pixel drive voltage supplied from the first power line 150 to the common power lines B1 to Bm. Therefore, the light emitting diode display according to the fifth embodiment of the present invention may minimize non-uniform current supplied to the pixels 121 on an M block basis.

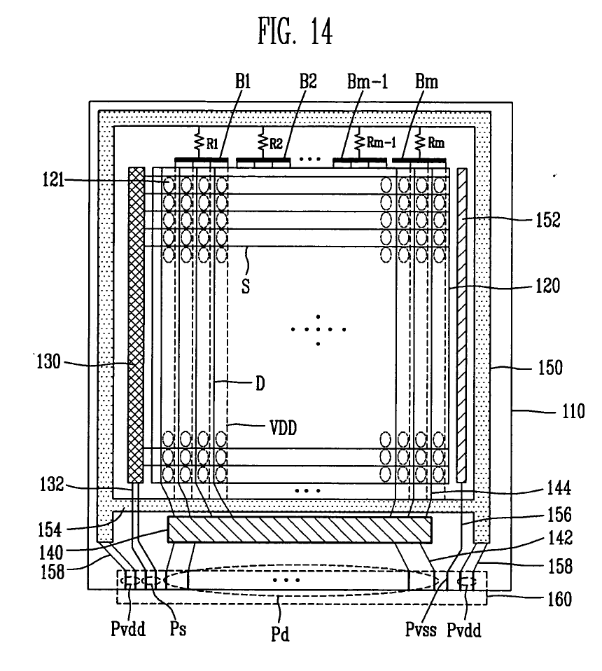

FIG. 14 is a diagram showing a light emitting diode display according to the sixth embodiment of the present invention.

Referring to FIG. 14, the light emitting diode display according to the sixth embodiment of the present invention may include the same elements as the display according to the fifth embodiment of the present invention, except that the former may further include an auxiliary power line 154. Thus, a description of the elements other than the auxiliary power line 154 of the light emitting diode display according to the sixth embodiment of the present invention will be omitted here.

The auxiliary power line 154 may be arranged adjacent to the lower side of the pixel portion 120. In other words, the auxiliary power line 154 may be formed between the parallel first power lines 150 and coupled to the first power line 150.

Accordingly, the first side of each pixel power line VDD may be coupled in common to the first power line 150 adjacent to the upper side of the pixel portion 120 through the respective compensation elements R1 to Rm and the common power lines B1 to Bm. Additionally, the second side of each pixel power line VDD may be coupled in common to the auxiliary power line 154. Thus, the first sides of the pixel power lines VDD may be supplied with the first pixel drive voltage via the first power line 150, the compensation elements R1 to Rm, and the common power lines B1 to Bm, and the second sides of the pixel power lines VDD may be supplied with the first pixel drive voltage via the first power line 150 and the auxiliary power line 154. The pixel power lines VDD supply the first pixel drive voltage to the respective pixels 121.

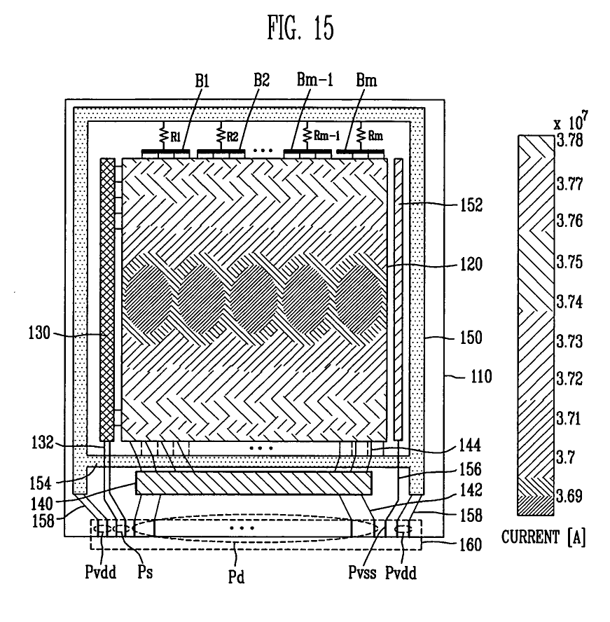

FIG. 15 is a diagram showing current distribution according to positions of the pixels of FIG. 14.

Referring to FIG. 15, the light emitting diode display according to the sixth embodiment of the present invention uses the compensation elements R1 to Rm to minimize the non-uniform voltage drop of the first pixel drive voltage supplied from the first power line 150 to the common power lines B1 to Bm. Additionally, the light emitting diode display according to the sixth embodiment of the present invention uses the compensation elements R1 to Rm, the common power lines B1 to Bm, and the auxiliary power line 154 to supply the first pixel drive voltage to the pixel power lines VDD to minimize the non-uniform current supplied to each pixel on an M block basis.

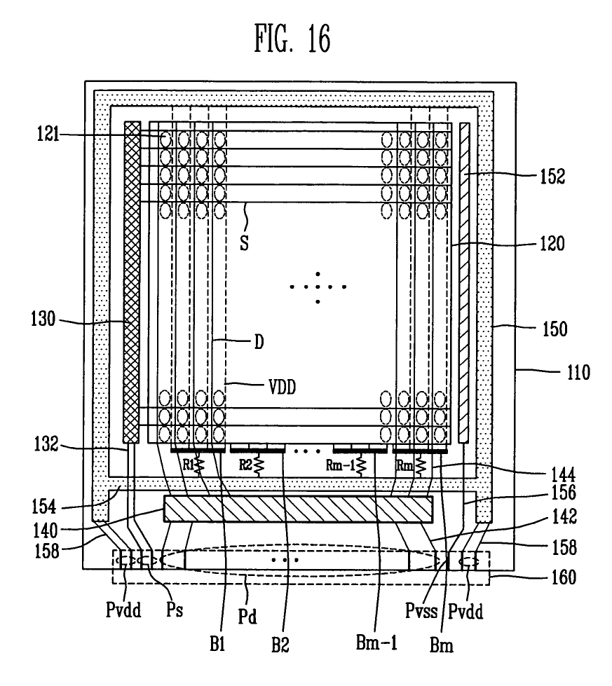

FIG. 16 is a diagram showing a light emitting diode display according to the seventh embodiment of the present invention.

Referring to FIG. 16, the light emitting diode display according to the seventh embodiment of the present invention is similar to the display according to the sixth embodiment of the present invention, except for an arrangement of the compensation elements R1 to Rm and the common power lines B1 to Bm. Thus, a description of the elements other than the compensation elements R1 to Rm and the common power lines B1 to Bm will be omitted here.

In the light emitting diode display according to the seventh embodiment of the present invention, each common power line B1 to Bm may be coupled in common to the second side of N pixel power lines VDD. Therefore, the pixel power lines VDD are divided into M blocks by the common power lines B1 to Bm, respectively. The common power lines B1 to Bm may be formed between the second sides of the pixel power lines VDD and the auxiliary power line 154.

The compensation elements R1 to Rm may be coupled between the common power lines B1 to Bm and the auxiliary power line 154. Further, the compensation elements R1 to Rm/2 may have different resistances from each other, and the compensation elements Rm/2+1 to Rm may have different resistances from each other. In other words, the compensation elements R1 to Rm may be formed with different linewidths, as shown in FIG. 3, or they may be formed with the same linewidths but different lengths, as shown in FIG. 4. The compensation elements R1 to Rm compensate for the impedance affecting the first pixel drive voltage supplied from the auxiliary power line 154 to the common power lines B1 to Bm. Consequently, the first pixel drive voltage supplied from the auxiliary power line 154 to the second sides of the pixel power lines VDD via the compensation elements R1 to Rm and the common power lines B1 to Bm may be substantially equal to the first pixel drive voltage supplied from the first power line 150 to the first sides of the pixel power lines VDD.

The first sides of the pixel power lines VDD may be coupled in common to the first power line 150 adjacent to the upper side of the pixel portion 120, and the second sides thereof may be coupled in common to the auxiliary power line 154 adjacent to the lower side of the pixel portion 120 through the common power lines B1 to Bm and the compensation elements R1 to Rm. Accordingly, the first side of each pixel power line VDD may be supplied with the first pixel drive voltage via the first power line 150, and the second side thereof may be supplied with the first pixel drive voltage via the auxiliary power line 154, the compensation elements R1 to Rm, and the common power lines B1 to Bm. The pixel power lines VDD supply the first pixel drive voltage to the pixels 121.

The light emitting diode display according to the seventh embodiment of the present invention supplies the first pixel drive voltage from the first power line 150 to the first sides of the pixel power lines VDD, and at the same time, uses the auxiliary power line 154, the compensation elements R1 to Rm, and the plurality of common power lines B1 to Bm to supply the first pixel drive voltage to the second sides of the pixel power lines VDD, so that non-uniform current supplied to each pixel 121 may be minimized on an M block basis.

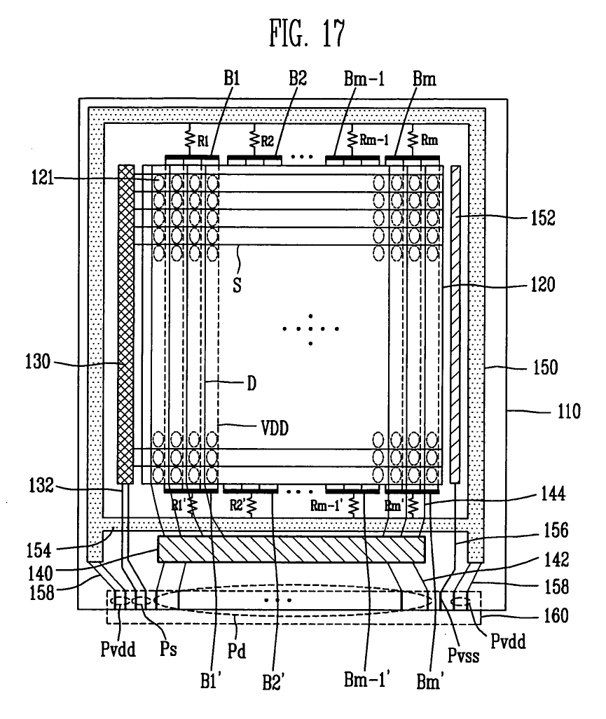

FIG. 17 is a diagram showing a light emitting diode display according to the eight embodiment of the present invention.

Referring to FIG. 17, the light emitting diode display according to the eight embodiment of the present invention is similar to the displays according to the sixth and seventh embodiments of the present invention, except for the inclusion of a plurality of first common power lines B1 to Bm coupled to first sides of N pixel power lines VDD; first compensation elements R1 to Rm coupled between the first common power lines B1 to Bm and the first power line 150; and a plurality of second common power lines B1′ to Bm′ coupled to the second sides of N pixel power lines VDD; and the second compensation elements R1′ and Rm′ coupled between the second common power lines B1′ to Bm′ and the auxiliary power line 154.

Thus, a description of the light emitting diode display according to the eight embodiment of the present invention will be omitted here since its elements were described with regard to the sixth and seventh embodiments of the present invention.

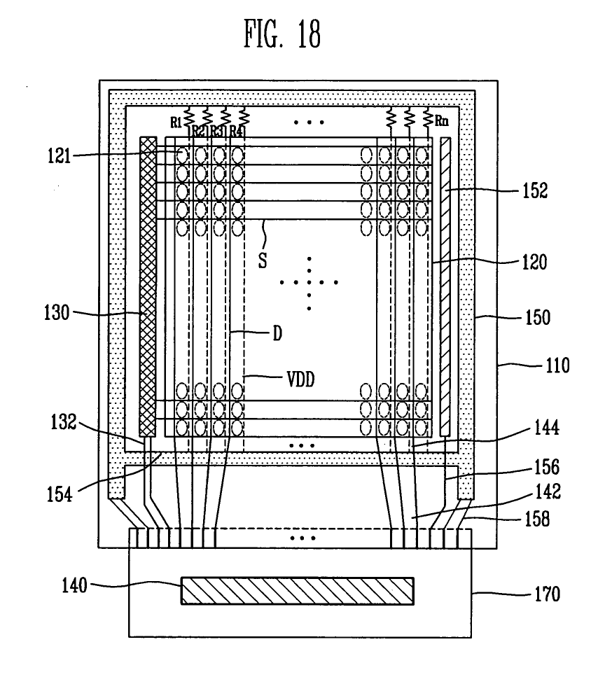

FIG. 18 is a diagram showing a light emitting diode display according to the ninth embodiment of the present invention.

Referring to FIG. 18, the light emitting diode display according to the ninth embodiment of the present invention may have the same elements as the displays according to the first through the eighth embodiments of the present invention, except for a data driver circuit 140 for supplying data signals to the pixel portion 120.

The data driver circuit 140 of the light emitting diode display according to the ninth embodiment of the present invention may be mounted on a flexible printed circuit 170, which may be coupled to the substrate 110. Thus, the data driver circuit 140 may be coupled to the data lines D of the pixel portion 120 through the pad portion of the substrate 110 to supply the data signals. Here, the data driver circuit 140 may be mounted on, for example, a film-type connection device employed in a chip on board mounted on the printed circuit board, the chip on film or the tap carrier package directly mounted on the film, in addition to the flexible printed circuit 170.

As described above, light emitting diode displays according to exemplary embodiments of the present invention may use compensation elements to minimize a voltage drop of the first power line adjacent to the pixel power line to achieve a substantially uniform luminance. Further, compensation elements may minimize a difference between the first power line and the auxiliary power line to achieve a substantially uniform luminance.

In addition, light emitting diode displays according to exemplary embodiments of the present invention may use compensation elements and common power lines to minimize the voltage drop of the first power line adjacent to the pixel power line to achieve substantially uniform luminance. Further, compensation elements and common power lines may minimize a difference between the first power line and the auxiliary power line to achieve substantially uniform luminance.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A light emitting diode display, comprising:
a pixel portion arranged on a substrate and having a plurality of data lines, scan lines, and pixels;
a first power line for supplying a first pixel drive voltage;
a plurality of pixel power lines coupled to the first power line for supplying the first pixel drive voltage to the pixels; and
a plurality of compensation elements coupled between respective pixel power lines and the first power line,
wherein the compensation elements have different resistances.

2. The light emitting diode display of claim 1, wherein compensation elements have different linewidths.

3. The light emitting diode display of claim 1, wherein compensation elements have different lengths.

4. The light emitting diode display of claim 1,
wherein the light emitting diode display comprises m compensation elements, and m is equal to a number of pixel power lines, and
wherein a resistance of each compensation element decreases from a first compensation element to an m/2-th compensation element, and increases from an (m/2+1)-th compensation element to an m-th compensation element.

5. The light emitting diode display of claim 4,
wherein a k-th compensation element has the same resistance as an (m+1−k)-th compensation element, and
wherein k is a positive integer.

6. The light emitting diode display of claim 1, wherein the first power line is formed along a first edge, a second edge, and a third edge of the substrate.

7. The light emitting diode display of claim 1, further comprising a second power line for supplying a second pixel drive voltage to the pixels, the second pixel drive voltage being different from the first pixel drive voltage.

8. A light emitting diode display, comprising:
a pixel portion arranged on a substrate and having a plurality of data lines, scan lines, and pixels;
a first power line arranged at a first side of the pixel portion and for supplying a first pixel drive voltage to the pixels;
an auxiliary power line arranged at a second side of the pixel portion and for supplying the first pixel drive voltage to the pixels;
a plurality of pixel power lines coupled to the first power line and the auxiliary power line for supplying the first pixel drive voltage from the first power line and the auxiliary power line to the pixels; and
a plurality of compensation elements coupled at least between respective pixel power lines and the first power line or between respective pixel power lines and the auxiliary power line,
wherein the compensation elements have different resistances.

9. The light emitting diode display of claim 8, wherein compensation elements have different linewidths.

10. The light emitting diode display of claim 8, wherein compensation elements have different lengths.

11. The light emitting diode display of claim 8,
wherein the light emitting diode display comprises m compensation elements, and m is equal to a number of pixel power lines, and
wherein a resistance of each compensation element decreases from a first compensation element to an m/2-th compensation element, and increases from an (m/2+1)-th compensation element to an m-th compensation element.

12. The light emitting diode display of claim 11,
wherein a k-th compensation element has the same resistance as an (m+1−k)-th compensation element, and
wherein k is a positive integer.

13. The light emitting diode display of claim 8, wherein the first power line is formed along a first edge, a second edge, and a third edge of the substrate, and is coupled to the auxiliary power line.

14. The light emitting diode display of claim 8, further comprising a second power line for supplying a second pixel drive voltage to the pixels, the second pixel drive voltage being different from the first pixel drive voltage.

15. The light emitting diode display of claim 8, wherein a compensation element is coupled between the first power line and each pixel power line.

16. The light emitting diode display of claim 8, wherein a compensation element is coupled between the auxiliary power line and each pixel power line.

17. The light emitting diode display of claim 8, wherein a compensation element is coupled between the first power line and each pixel power line, and a compensation element is coupled between the auxiliary power line and each pixel power line.

18. A light emitting diode display, comprising:
a pixel portion arranged on a substrate and having a plurality of data lines, scan lines, and pixels;
a first power line for supplying a first pixel drive voltage to the pixels;
a plurality of pixel power lines coupled to the first power line for supplying the first pixel drive voltage to the pixels;
a plurality of common power lines, each common power line being coupled in common to m pixel power lines, m being a positive integer; and
a plurality of compensation elements coupled between respective common power lines and the first power line,
wherein the compensation elements have different resistances.

19. The light emitting diode display of claim 18, wherein compensation elements have different linewidths.

20. The light emitting diode display of claim 18, wherein compensation elements have different lengths.

21. The light emitting diode display of claim 18, wherein the first power line is formed along a first edge, a second edge, and a third edge of the substrate.

22. The light emitting diode display of claim 18, further comprising a second power line for supplying a second pixel drive voltage to the pixels, the second pixel drive voltage being different from the first pixel drive voltage.

23. A light emitting diode display, comprising:
a pixel portion arranged on a substrate and having a plurality of data lines, scan lines, and pixels;
a first power line arranged at a first side of the pixel portion and for supplying a first pixel drive voltage to the pixels;
an auxiliary power line arranged at a second side of the pixel portion and for supplying the first pixel drive voltage to the pixels;
a plurality of pixel power lines coupled to the first power line and the auxiliary power line for supplying the first pixel drive voltage from the first power line and the auxiliary power line to the pixels;
a plurality of common power lines, each common power line being coupled in common to at least one of a first side and a second side of m pixel power lines, m being a positive integer; and
a plurality of compensation elements coupled at least between respective common power lines and the first power line or between respective common power lines and the auxiliary power line,
wherein the compensation elements have different resistances.

24. The light emitting diode display of claim 23, wherein compensation elements have different linewidths.

25. The light emitting diode display of claim 23, wherein compensation elements have different lengths.

26. The light emitting diode display of claim 23, wherein the first power line is formed along a first edge, a second edge, and a third edge of the substrate, and is coupled to the auxiliary power line.

27. The light emitting diode display of claim 23, further comprising a second power line for supplying a second pixel drive voltage to the pixels, the second pixel drive voltage being different from the first pixel drive voltage.

28. The light emitting diode display of claim 23, wherein a compensation element is coupled between the first power line and each pixel power line.

29. The light emitting diode display of claim 23, wherein a compensation element is coupled between the auxiliary power line and each pixel power line.

30. The light emitting diode display of claim 23, wherein a compensation element is coupled between the first power line and each pixel power line, and a compensation element is coupled between the auxiliary power line and each pixel power line.

31. The light emitting diode display of claim 1, wherein a compensation element is coupled between each pixel power line and the first power line.
